(19) United States
(12) Patent Application Publication
(10) Pub. No.: US 2025/0145123 A1
(43) Pub. Date: May 8, 2025

(54) System for Controlling Service Braking in Auxiliary Axle Wheel Brakes

(71) Applicant: Bendix Commercial Vehicle Systems LLC, Avon, OH (US)

(72) Inventors: Ryan S. Hurley, Lakewood, OH (US); David W. Howell, Oak Ridge, NC (US); Brandon Ferrell, High Point, NC (US); Randy J. Salvatora, Columbia Station, OH (US)

(21) Appl. No.: 18/502,422

(22) Filed: Nov. 6, 2023

(51) Int. Cl. B60T 8/36; B60T 13/68

(52) U.S. Cl. CPC B60T 8/361; B60T 13/683

(57) ABSTRACT

A system for controlling a wheel brake on an auxiliary axle of a vehicle includes an electro-pneumatic drive axle brake control valve that deliver fluid pressure from a fluid source to a drive axle wheel brake on a drive axle of the vehicle responsive to an electronic control signal. An auxiliary axle brake control valve delivers fluid pressure from the electro-pneumatic drive axle brake control valve to an auxiliary axle wheel brake on the auxiliary axle of the vehicle responsive to a fluid pressure control signal. A fluid control signal generating valve generates the fluid pressure control signal responsive to a command to apply a steer axle wheel brake on a steer axle of the vehicle.

### BACKGROUND OF THE INVENTION

### a. Field of the Invention

This disclosure relates to braking systems for vehicles. In particular, this disclosure relates to a system for controlling wheel brakes on an auxiliary axle of a vehicle in which wheel brakes on other axles in the vehicle are controlled using an electronic-over-air brake subsystem (hereinafter referred to as electronic braking system).

### b. Background Art

The use of electronic braking systems to control wheel brakes in vehicles is continuously increasing. As compared to conventional fluid control of wheel brakes, electronic braking systems offer several advantages. Electronic braking systems shorten the response time between a brake command and application of the brakes because electrical control signals travel faster than fluid control signals. Electronic braking systems also allow more accurate control of brake pressure due to the use of pressure sensors and other feedback systems. Electronic brake systems also allow brake pressure to be set independently of the position of operator controls such as brake pedals.

Some conventional electronic braking systems are only capable of controlling the wheel brakes on a limited number of axles or on certain types of axles (e.g., drive and steer axles, but not liftable or other auxiliary axles). As a result, the number and type of vehicles on which these conventional electronic brake systems may be used may be limited without costly and complex changes to the braking system. Therefore, there is a need for a system that will extend control of existing electronic braking systems to wheel brakes on auxiliary axles that are not directly controlled by the electronic braking system. The system, however, must also account for conditions in which control of auxiliary axle wheel brakes should be independent of control of wheel brakes on axles that are directly controlled by the existing electronic braking system (e.g., in a traction control event or when a liftable auxiliary axle is a lifted position).

The inventors herein have recognized a need for a system for controlling a wheel brake on an auxiliary axle of a vehicle that will minimize and/or eliminate one or more of the above-identified deficiencies.

### BRIEF SUMMARY OF THE INVENTION

This disclosure relates to braking systems for vehicles. In particular, this disclosure relates to a system for controlling wheel brakes on an auxiliary axle of a vehicle in which wheel brakes on other axles in the vehicle are controlled using an electronic braking system

One embodiment of a system for controlling a wheel brake on an auxiliary axle of a vehicle includes an electro-pneumatic drive axle brake control valve configured to deliver fluid pressure from a fluid source to a drive axle wheel brake on a drive axle of the vehicle responsive to an electronic control signal. The system further includes an auxiliary axle brake control valve configured to deliver fluid pressure from the electro-pneumatic drive axle brake control valve to an auxiliary axle wheel brake on the auxiliary axle of the vehicle responsive to a fluid pressure control signal. The system further includes a fluid control signal generating valve configured to generate the fluid pressure control signal responsive to a command to apply a steer axle wheel brake on a steer axle of the vehicle.

Another embodiment of a system for controlling a wheel brake on an auxiliary axle of a vehicle includes an electro-pneumatic drive axle brake control valve configured to deliver fluid pressure from a fluid source to a drive axle wheel brake on a drive axle of the vehicle responsive to an electronic control signal. The system further includes means for delivering fluid pressure from the electro-pneumatic drive axle brake control valve to an auxiliary axle wheel brake on the auxiliary axle of the vehicle responsive to a fluid pressure control signal. The system further includes means for generating the fluid pressure control signal responsive to a command to apply a steer axle wheel brake on a steer axle of the vehicle.

A system for controlling a wheel brake on an auxiliary axle of a vehicle in accordance with the teachings disclosed herein is advantageous relative to conventional systems. In particular, the system allows an electronic braking system used in controlling wheel brakes on other axles of the vehicle (e.g., the drive axle) to indirectly control wheel brakes on the auxiliary axles of a vehicle using components of the electronic braking system and additional fluid control components. The system therefore enables existing electronic braking systems to control wheel brakes on more axles, and different types of axles, than the electronic braking system may be configured to control with relatively simple and inexpensive changes to the braking system. As a result, the system enables use of existing electronic braking systems with a larger number of vehicles and types of vehicles. The system may also allow the extension of certain braking functionality (such as anti-lock braking (ABS)) to the auxiliary axle without the addition of dedicated wheel speed sensors and other components of a conventional ABS system. In accordance with one aspect of the systems disclosed herein, the system is also capable of disabling control of the wheel brakes on the auxiliary axle by the electronic braking system in certain conditions where is may be undesirable for control of auxiliary axle wheel brakes to follow control of wheel brakes on other axles (e.g., in a traction control event or when a liftable auxiliary axle is a lifted position).

The foregoing and other aspects, features, details, utilities, and advantages of the present teachings will be apparent from reading the following description and claims, and from reviewing the accompanying drawings.

### BRIEF DESCRIPTION OF THE DRAWINGS

FIG. 1 is a diagrammatic view of a vehicle incorporating a system for controlling a wheel brake on an auxiliary axle of the vehicle in accordance with the teachings set forth herein.

FIG. 2 is a diagrammatic view of one embodiment of a system for controlling a wheel brake on an auxiliary axle of the vehicle in accordance with the teachings set forth herein.

FIG. 3 is a diagrammatic view of another embodiment of a system for controlling a wheel brake on an auxiliary axle of the vehicle in accordance with the teachings set forth herein.

FIG. 4 is a diagrammatic view of another embodiment of a system for controlling a wheel brake on an auxiliary axle of the vehicle in accordance with the teachings set forth herein.

### DETAILED DESCRIPTION OF THE INVENTION

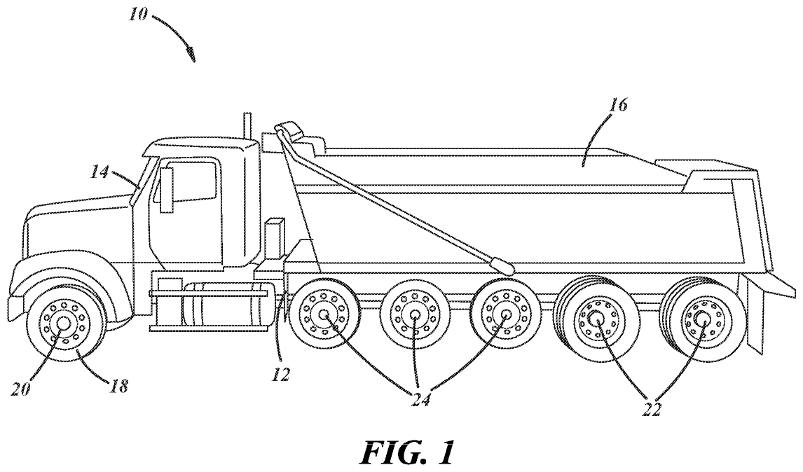

Referring now to the drawings wherein like reference numerals are used to identify identical components in the various views, FIG. 1 illustrates a vehicle 10. In the illustrated embodiment, vehicle 10 comprises a heavy commercial vehicle and, for example, a dump truck. It should be understood, however, that the systems disclosed herein may find application on other types of commercial vehicles including, for example, cement mixers, heavy tow trucks and other large vocational vehicles requiring auxiliary axles and may also find application on non-commercial vehicles.

Vehicle 10 includes a frame or chassis 12 configured to support a cabin 14 for the vehicle operator and a container 16 for a load that may be moved from the flat position shown in FIG. 1 to an inclined position to dump the load. Chassis 12 may be further configured to support other conventional vehicle components and systems including, for example, a power unit such as an internal combustion engine or motor fueled, for example, by an alternative power source such as an electric battery of fuel cell for generating mechanical energy used to rotate wheels 18 on vehicle 10 and a battery that may provide electrical energy for starting the power unit and for use by various systems on vehicle 10 including, for example, components of the braking system described hereinbelow.

Chassis 12 is supported on a plurality of axles that support and position wheels 18 on opposite lateral sides of vehicle 10 including a steer axle 20, one or more drive axles 22 and one or more auxiliary axles 24. Steer axle 20 supports wheels 18 that are steerable by the vehicle operator to establish the path of travel for vehicle 10. Drive axles 22 support wheels 18 that are driven by the power unit in vehicle 10 to cause movement of vehicle 10. Auxiliary axles 24 support wheels 18 that are used to provide additional support for loads carried by vehicle 10. As used herein, an auxiliary axle 24 is an axle that is not directly steered by the vehicle operator nor directly driven by the vehicle power unit. In some embodiments, auxiliary axles 24 comprise liftable axles that have an inactive state in which the auxiliary axles 24 are in a lifted or raised position and the wheels 18 on auxiliary axles 24 are not in contact with the ground and an active state in which the auxiliary axles 24 are in an unlifted or unraised position and the wheels 18 on auxiliary axles 24 are in contact with the ground. In the illustrated embodiment, auxiliary axles 24 are located forward of the drive axles 22 (i.e., pusher axles). It should be understood, however, that the systems described herein could be used on auxiliary axles 24 that are located rearward of the drive axles 22 on chassis 12 (i.e., tag axles) or rearward of drive axles 22 on a separate frame or chassis (i.e., boom or bridge axles).

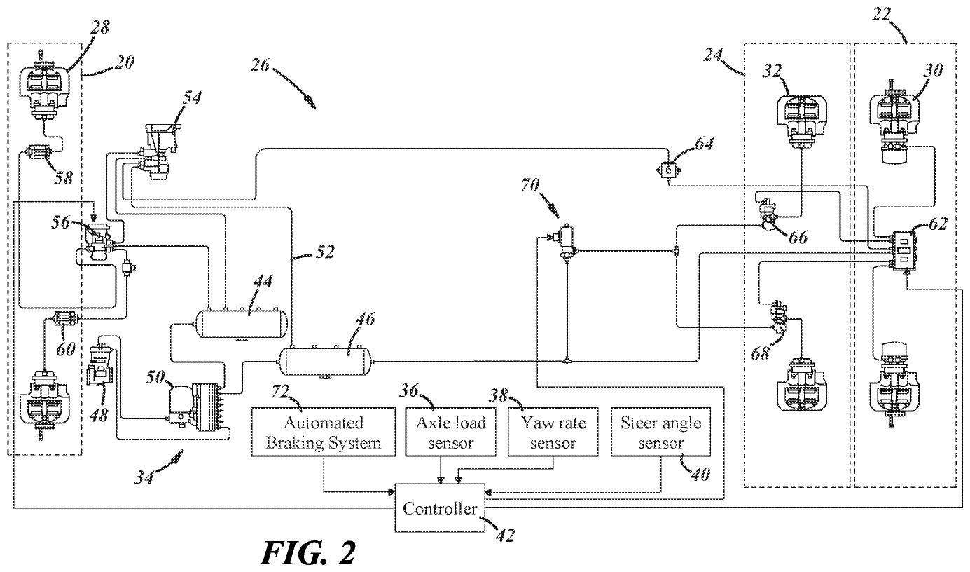

Referring now to FIG. 2, vehicle 10 may further include a braking system 26. System 26 is provided to slow, stop or prevent rotation of wheels 18 and, therefore, movement of vehicle 10. In accordance with the teachings herein, system 26 includes components of an electronic braking system used in controlling wheel brakes 28, 30 on steer axle 20 and drive axle 22, respectively, and further provides a system for controlling one more wheel brakes 32 on auxiliary axle 24. In addition to wheel brakes 28, 30, 32, braking system 26 may include a fluid circuit 34 that supplies fluid pressure to wheel brakes 28, 30, 32, various sensors 36, 38, 40 that provide information regarding the operation of vehicle 10 and/or the operating environment for vehicle 10, and one or more controllers 42. Although a single steer axle 20, drive axle 22 and auxiliary axle 24 are illustrated in FIG. 2, it should be understood that additional steer axles 20, drive axles 22 and auxiliary axles 24 may be configured in a similar manner to allow for control of additional axles 20, 22, 24 in vehicle 10.

Wheel brakes 28, 30, 32 are configured to apply a braking force to one or more wheels 18. In the illustrated embodiment, brakes 28, 30, 32 comprise disc brakes in which a carrier supports brake pads on opposite sides of a rotor rotating with the wheel 18 and an actuator causes, responsive to fluid pressure delivered by fluid circuit 34, movement of a caliper relative to the carrier to move the brake pads into and out of engagement with the rotor. Alternatively, wheel brakes 28, 30, 32 may comprise drum brakes in which an actuator such as a cam or piston causes, responsive to fluid pressure delivered by circuit 34, movement of one or more brake shoes into engagement with a braking surface in a brake drum rotating with the wheel 18. Wheel brakes 28, 30, 32 may be configured to function as both a service brake for applying service braking while vehicle 10 is an active state and as a parking brake for applying parking or emergency braking while vehicle 10 is an active or inactive state.

Fluid circuit 34 generates fluid pressure within braking system 26 and controls the delivery of fluid pressure to the actuator of each wheel brake 28, 30, 32. Circuit 34 may include components for generating and storing pressurized fluid including fluid reservoirs 44, 46, a compressor 48, and an air treatment module 50 and components for routing and delivering fluid pressure to wheel brakes 28, 30, 32 including fluid conduits 52 and various valves including food brake valve 54, an electro-pneumatic steer axle brake control valve 56, modulators 58, 60, an electro-pneumatic drive axle brake control valve 62, a quick release valve 64, auxiliary axle brake control valves 66, 68, and a fluid control signal generating valve 70.

Fluid reservoirs 44, 46 store compressed fluid for use in applying wheel brakes 28, 30, 32. Reservoir 44 supplies pressurized fluid to the wheel brakes 28 for steer axle 20 and has a fluid port coupled to air treatment module 50 and fluid ports coupled to foot brake valve 54 and electro-pneumatic steer axle brake control valve 56. Reservoir 46 supplies pressurized fluid to the wheel brakes 30, 32 for drive axle 22 and auxiliary axle 24 and has a fluid port coupled to air treatment module 50 and fluid ports coupled to foot brake valve 54 and electro-pneumatic drive axle brake control valve 62. The fluid conduit 52 extending between fluid reservoir 46 and electro-pneumatic drive axle brake control valve 62 further branches to supply fluid pressure to fluid control signal generating valve 70.

Compressor 48 draws in air and compresses the air for delivery to reservoirs 44, 46, through air treatment module 50. Compressor 48 has one or more fluid ports coupled to air treatment nodule 50.

Air treatment module 50 is provided to collect and remove solid, liquid and vapor contaminants from pressurized fluid provided by compressor 48. Air treatment module 50 is disposed between compressor 48 and reservoirs 44, 46 and has fluid ports coupled to compressor 48 and each reservoir 44, 46.

Fluid conduits 52 are used to transport fluid between reservoirs 44, 46, compressor 48, air treatment module 50, valves 54, 56, 58, 60, 62, 64, 66, 68, 70 and wheel brakes 28, 30, 32. Conduits 52 may be made from conventional metals and/or plastics and have connectors at either end configured to join the conduits 52 to corresponding components of circuit 34.

Foot brake valve 54 provides an interface through which the vehicle operator may input a command to apply wheel brakes 28, 30, 32 and control the delivery of fluid pressure to wheel brakes 28, 30, 32 for service braking. Valve 54 includes a brake pedal that may be actuated by the operator. Actuation of the brake pedal opens a valving member in foot brake valve 54 that allows fluid pressure from reservoirs 44, 46 to flow to electro-pneumatic steer axle brake control valve 56 and to quick release valve 64, respectively. A position sensor may generate a signal indicative of the position of the brake pedal and that signal may be provided to controller 42 for use in controlling fluid control signal generating valve 70 as discussed in more detail below.

Electro-pneumatic steer axle brake control valve 56 is provided to control delivery of fluid pressure to wheel brakes 28 on steer axle 20. Valve 56 includes a relay valve that delivers fluid pressure from reservoir 44 to wheel brakes 28 or exhausts fluid pressure from wheel brakes 28 responsive to a control pressure. The relay valve increases the volume of fluid, and therefore the flow, at which fluid is delivered to, and exhausted from, wheel brakes 28 in order to reduce lag times between the commanded and actual application and release of wheel brakes 28. Valve 56 further includes solenoid valves configured to establish the control pressure and, therefore, control the operation of the relay valve. An electronic control unit in valve 56 controls the operation of solenoid valves responsive to control signals from controller 42 and may further process signals from a pressure sensor within valve 56 and from wheel speed sensors and brake lining wear sensors associated with wheels 18 and wheel brakes 28, respectively, at each end of steer axle 20. Valve 56 may generate signals indicative of fluid pressure, wheel speed and brake lining wear and transmit those signals to controller 42 and other vehicle systems over a conventional vehicle communications bus implementing a communications network such as a controller area network (CAN) or local interconnect network (LIN) or over a vehicle power line through power line communication (PLC) in accordance with various industry standard protocols including by not limited to SAE J1939, SAEJ1922, and SAE J2497 or using a proprietary protocol.

Modulators 58, 60 are provided to implement anti-lock braking and electronic stability control functions. During normal braking, modulators 58, 60 allow fluid pressure to pass from electro-pneumatic steer axle brake control valve 56 to wheel brakes 28 without interference. During a loss of traction, however, signals from controller 42 or another system on vehicle 10 cause modulators 58, 60 to modulate the fluid pressure to prevent lockup of the wheels 18. Modulators 58, 60 have supply ports coupled to delivery ports in electro-pneumatic steer axle brake control valve 56 and delivery ports coupled to wheel brakes 28.

Electro-pneumatic drive axle brake control valve 62 is provided to control delivery of fluid pressure to wheel brakes 30 on drive axle 22. Valve 62 may be configured with two fluid channels to allow variation in the fluid pressure delivered to the wheel brakes 30 on either side of vehicle 10 for implementation of traction control. Valve 62 may therefore include a pair of relay valves that deliver fluid pressure from reservoir 46 to wheel brakes 30 or exhausts fluid pressure from wheel brakes 30 responsive to a control pressure. The relay valves increase the volume of fluid, and therefore the flow, at which fluid is delivered to, and exhausted from, wheel brakes 30 in order to reduce lag times between the commanded and actual application and release of brakes 30. Valve 62 further includes solenoid valves configured to establish the control pressure and, therefore, control the operation of each relay valve. An electronic control unit in valve 62 controls the operation of the solenoid valves responsive to control signals from controller 42 and may further process signals from pressure sensors within valve 62 and from wheel speed sensors and brake lining wear sensors associated with wheels 18 and wheel brakes 30, respectively, at each end of drive axle 22. Valve 62 may generate signals indicative of fluid pressure, wheel speed and brake lining wear and transmit those signals to controller 42 and other vehicle systems over the communications bus or power line referenced hereinabove.

Quick release valve 64 transmits fluid pressure from foot brake valve 54 to electro-pneumatic drive axle brake control valve 62 (as a backup measure for control of valve 62 in the event of a loss of electronic control of valve 62). Valve 64 may comprise the valve offered for sale by the applicant Bendix Commercial Vehicle Systems LLC, under the registered trademark QR-1®. Valve 64 has a supply port in fluid communication with a delivery port of foot brake valve 54 and a delivery port in fluid communication with a supply port on electro-pneumatic drive axle brake control valve 62.

Auxiliary axle brake control valves 66, 68 function as high-flow synchro valves and are provided to synchronize (i) the fluid pressure provided to the wheel brakes 30 on each lateral side of drive axle 22 on vehicle 10 by electro-pneumatic drive axle brake control valve 62 and (ii) the fluid pressure provided to the corresponding wheel brakes 32 on each lateral side of auxiliary axle 24 on vehicle 10. Each auxiliary axle brake control valve 66, 68 may comprise a variation of the valve offered for sale by the applicant Bendix Commercial Vehicle Systems LLC, under the model number TP-3DC™. Auxiliary axle brake control valves 66, 68 are pneumatically actuated and each auxiliary axle brake control valve 66, 68 is configured to deliver fluid pressure from the electro-pneumatic drive axle brake control valve 62 to a wheel brake 32 on auxiliary axle 24 of vehicle 10 responsive to a fluid pressure control signal generated by fluid control signal generating valve 70. In the illustrated embodiment, each auxiliary axle brake control valve 66, 68 has a supply port coupled to a delivery port of electro-pneumatic drive axle brake control valve 62 that is configured to receive fluid pressure from valve 62 and, indirectly from reservoir 46. It should be understood, however, that each auxiliary brake control valve 66, 68 may be indirectly supplied by any reservoir on vehicle 10. Each auxiliary axle brake control valve 66, 68 has a delivery port coupled to a corresponding wheel brake 32 on auxiliary axle 24. Finally, each auxiliary axle brake control valve 66, 68 has a control port coupled to a delivery port of fluid control signal generating valve 70. When fluid control signal generating valve 70 delivers fluid pressure to the control port of each auxiliary axle brake control valve 66, 68, valves 66, 68 open to allow fluid pressure to flow from electro-pneumatic drive axle brake control valve 62 to the wheel brakes 32 on auxiliary axle 24 whenever the braking system 26 has been commanded to deliver pressure. As a result, service braking applied to wheel brakes 30 on drive axle 22 can also be applied to wheel brakes 32 on auxiliary axle 24 thereby allowing an extension of the functionality of the electronic braking system to auxiliary axle 24 including anti-lock braking functionality on drive axle 22 implemented through electro-pneumatic drive axle brake control valve 62.

Fluid control signal generating valve 70 is provided to control auxiliary axle brake control valves 66, 68 and, as a result, the delivery of fluid pressure to wheel brakes 32 on auxiliary axle 24. In accordance with one aspect of the systems disclosed herein, valve 70 is configured to generate and transmit a fluid pressure control signal to valves 66, 68 responsive to a command to apply a wheel brake 28 on steer axle 20 of vehicle 10. As a result, auxiliary axle brake control valves 66, 68 will only provide fluid pressure to wheel brakes 32 on auxiliary axle 24, and wheel brakes 32 on auxiliary axle 24 will only be applied, when fluid pressure is being supplied to the wheel brakes 28, 30 on both of steer axle 20 and drive axle 22. As discussed below, this command may be generated as a result of an operator input (through, for example, foot pedal valve 54) or by an automated braking system. Because valve 70 can be electronically controlled, it will only generate the fluid pressure control signal when it is appropriate. Auxiliary axle brake control valves 66, 68 will not provide fluid pressure to wheel brakes 32 on auxiliary axle 24 in conditions, such as a loss of traction control, where only the wheel brakes 30 on drive axle 22 are meant to be actuated and the actuation of wheel brakes 32 on auxiliary axle 24 would hinder efforts to address the condition. Fluid control signal generating valve 70 may comprise a solenoid valve having a supply port coupled to a delivery port of fluid reservoir 46 and a delivery port coupled to the control port of each auxiliary axle brake control valve 66, 68. Fluid control signal generating valve 70 has an open state in which fluid pressure passes through fluid control signal generation valve 70 to the control ports on auxiliary axle brake control valves 66, 68 and a closed state in which fluid pressure is prevented from reaching the control ports on auxiliary axle brake control valves 66, 68. The state of fluid control signal generating valve 70 is determined responsive to an electrical control signal generated by controller 42 or by any other controlled configured to provide appropriate commands.

Sensors 36, 38, 40 generate signals indicative of an operating condition of vehicle 10 and/or the operating environment for vehicle 10 that may impact whether or not to brake vehicle 10 and how to brake vehicle 10 (e.g., the amount of braking force that should be applied, the particular wheel brakes 28, 30, 32 that should be actuated, etc.). In the illustrated embodiment, sensor 36 comprises an axle load sensor configured to generate a signal indicative of a load on one or more of axles 20, 22, 24. Controller 42 and/or a separate stability control system in vehicle 10 may evaluate the stability of vehicle 10 responsive to signals from sensor 36. Sensor 36 may comprise a strain gauge, piezoelectric sensor or a fluid (hydraulic or pneumatic) sensor. Sensor 38 comprises a steer angle sensor configured to generate a signal indicative of a steering angle imparted by a vehicle operator to a steering wheel in vehicle 10 while sensor 40 comprises a yaw rate sensor configured to generate a signal indicative of the angular velocity of vehicle 10 about its vertical (yaw) axis. Controller 42 and/or a separate traction control system in vehicle 10 may determine whether there has been a loss of traction responsive to signals from sensors 38, 40. In particular, controller 42 and/or a separate traction control system may compare signals from sensors 38, 40 to determine whether the intended direction of travel for vehicle 10 (as indicated by sensor 38) matches the actual direction of travel (as indicated by sensor 40) and thereby determine whether there has been a loss of traction between wheels 18 and the road.

Controller 42 controls the operation of certain components of fluid circuit 34 in order to control the fluid pressure delivered to wheel brakes 28, 30, 32 and, therefore, the braking force applied to the wheels 18. In this manner, controller 42 may be configured to implement service braking as well as anti-lock braking (ABS), traction control and stability control when required. Controller 42 may comprise a programmable microprocessor or microcontroller or may comprise an application specific integrated circuit (ASIC). Controller 42 may include a memory and a central processing unit (CPU). Controller 42 may also include an input/output (I/O) interface including a plurality of input/output pins or terminals through which the controller 42 may receive a plurality of input signals and transmit a plurality of output signals. The input signals may, for example, include signals received from electro-pneumatic steer axle brake control valve 56 and electro-pneumatic drive axle brake control valve 62 indicative of fluid pressure, wheel speed and/or brake lining wear associated with corresponding wheel brakes 28, 30 on steer axle 20 and drive axle 22 and signals from sensors 36, 38, 40. In accordance with one aspect of the systems disclosed herein, the input signals may further include signals indicative of a command to apply wheel brakes 28 on steer axle 20. These signals may be generated in response to an input from an operator of vehicle 10. For example, a foot pedal position sensor associated with foot pedal valve 54 may generate a signal indicative of actuation of the food pedal and, therefore, a command by the vehicle operator to apply wheel brakes 28. The signals may alternatively be generated in response to a command by an automated braking system 72 on vehicle 10 (i.e., an external brake request) configured to provide one or more of the following functions: automated emergency braking (AEB), anti-lock braking (ABS), collision avoidance, adaptive cruise control, traction control or stability control. System 72 may comprise an advanced driver assistance system (ADAS) or autonomous driving system (ADS). The output signals transmitted through the I/O interface of controller 42 may include signals used to control components of fluid circuit 34 such as electro-pneumatic steer axle brake control valve 56, electro-pneumatic drive axle brake control valve 62 and fluid control signal generating valve 70. Controller 42 may be configured to communicate with one or more other components of braking system 26 directly using dedicated (hard) wire connections. Alternatively, or in addition, controller 42 may be configured to communicate with one or more other components of braking system 26 over a vehicle communications bus or power line as referenced hereinabove.

In accordance with one aspect of the systems disclosed herein, controller 42 generates and transmits electrical control signals to fluid control signal generating valve 70 in response to commands to apply wheel brakes 28 on steer axle 20 of vehicle 10. As noted above, these commands may result from an operator input or from an automated braking system 72. Upon receipt of a signal indicative of a command to apply wheel brakes 28 on steer axle 20, controller 42 may generate and transmit an electrical control signal to fluid control signal generating valve 70 configured to cause valve 70 to move from a closed state to an open state and to generate and transmit a fluid pressure control signal to auxiliary axle brake control valves 66, 68. The fluid pressure control signal causes valves 66, 68 to allow fluid pressure (received from electro-pneumatic drive axle brake control valve 62) to be delivered to wheel brakes 32 on auxiliary axle 24.

In accordance with another aspect of the systems disclosed herein, controller 42 may be further configured to prohibit generation of the electrical control signal to fluid control signal generating valve 70, despite a command to apply the wheel brakes 28 on steer axle 20, if auxiliary axle 24 is in an inactive state. As discussed hereinabove, auxiliary axles 24 may comprise liftable axles that have an inactive state in which the auxiliary axles 24 are in a lifted or raised position and wheels 18 on auxiliary axles 24 are not in contact with the ground and an active state in which the auxiliary axles 24 are in an unlifted or unraised position and wheels 18 on auxiliary axles 24 are in contact with the ground. Actuation of wheel brakes 32 on auxiliary axle 24 when auxiliary axle 24 is in an inactive state would not generate any braking force on vehicle 10 and, conversely, may result in an unnecessary reduction in fluid pressure in system 26 and unnecessary wear on components of system 26. Controller 42 may determine that auxiliary axle 24 is in an inactive state in a variety of ways. For example, controller 42 may receive signals from a variety of sensors and control systems on vehicle 10 indicative of the state of auxiliary axle 42 including sensors indicative of the position of suspension components for auxiliary axle 24 and/or fluid pressure for a lift bag for auxiliary axle 24.

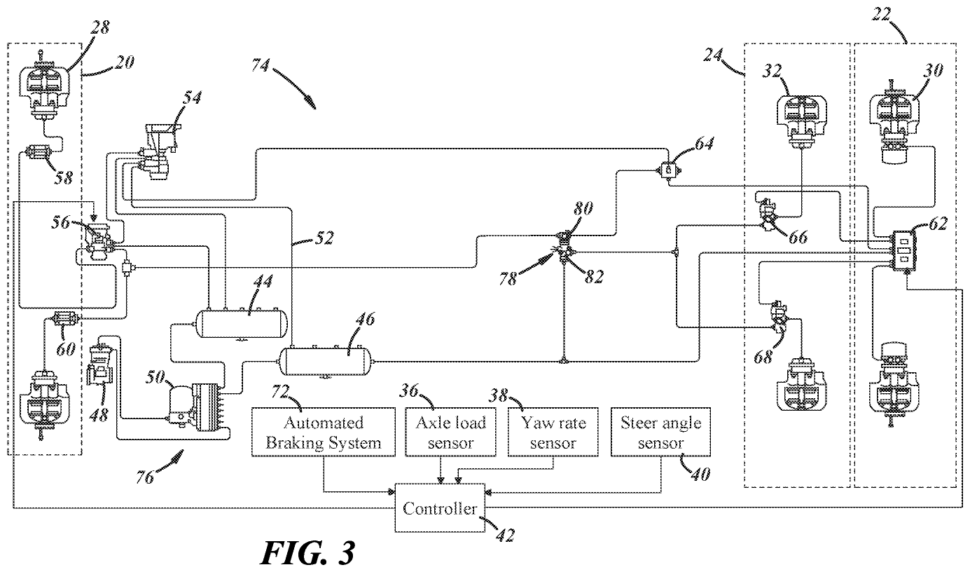

Referring now to FIG. 3, another embodiment of a brake system 74 for a vehicle 10 is illustrated. Like system 26, system 74 is provided to slow, stop or prevent rotation of wheels 18 and, therefore, movement of vehicle 10. System 74 is similar to system 26 and a description of similar components including wheel brakes 28, 30, 32, sensors 36, 38, 40, and controller 42 may be found hereinabove. System 74 differs from system 26 in that system 74 includes a different fluid circuit 76 relative to fluid circuit 34 in system 26. Fluid circuit 76 is substantially similar to fluid circuit 34 and a description of like components including fluid reservoirs 44, 46, compressor 48, air treatment module 50, fluid conduits 52, foot brake valve 54, electro-pneumatic steer axle brake control valve 56, modulators 58, 60, electro-pneumatic drive axle brake control valve 62, quick release vale 64, and auxiliary axle brake control valves 66, 68 may be found hereinabove. Fluid circuit 76 differs from fluid circuit 34 in that fluid circuit 76 includes a pneumatically controlled fluid pressure control signal generating valve 78 as opposed to the electrically controlled fluid pressure control signal generating valve 70 in fluid circuit 34.

Fluid control signal generating valve 78 is again provided to control auxiliary axle brake control valves 66, 68 and, as a result, the delivery of fluid pressure to wheel brakes 32 on auxiliary axle 24. In accordance with one aspect of the systems disclosed herein, valve 78 is again configured to generate and transmit a fluid pressure control signal to valves 66, 68 responsive to a command to apply a wheel brake 28 on steer axle 20 of vehicle 10. As a result, auxiliary axle brake control valves 66, 68 will only provide fluid pressure to wheel brakes 32 on auxiliary axle 24, and wheel brakes 32 on auxiliary axle 24 will only be applied, when fluid pressure is being supplied to the wheel brakes 28, 30 on both of steer axle 20 and drive axle 22. This command may again be generated as a result of an operator input (through, for example, foot pedal valve 54) or by an automated braking system 72. Because valve 78 only generates the fluid pressure control signal when there is a command to apply wheel brakes 28 on steer axle 22, auxiliary axle brake control valves 66, 68 will not allow fluid pressure to flow to wheel brakes 32 on auxiliary axle 24 in conditions, such as a loss of traction control, where only the wheel brakes 30 on drive axle 22 are meant to be actuated and the actuation of wheel brakes 32 on auxiliary axle 24 would hinder efforts to address the condition. Fluid control signal generating valve 78 may include a double check valve 80 and a synchro valve 82.

Double check valve 80 is provided to deliver the greater of two fluid pressures received by valve 80. Double check valve 80 may comprise the valve offered for sale by the applicant Bendix Commercial Vehicle Systems LLC under the registered trademark DC-4®. One supply port of valve 80 is configure to receive fluid pressure from an operator-controlled valve and, in the illustrated embodiment, foot pedal valve 54, that is configured to deliver fluid pressure from fluid sources such as fluid reservoirs 44, 46 to wheel brakes 28, 30, respectively, on steer axle 20 and drive axle 22. Another supply port of valve 80 is configured to receive fluid pressure from electro-pneumatic steer axle brake control valve 56 that is also configured to deliver fluid pressure from a fluid source such as fluid reservoir 44 to wheel brakes 28 on steer axle 20 responsive to fluid control signals from food pedal valve 54 and/or electronic control signals from controller 42. A delivery port on valve 80 is configured to output the higher of the fluid pressure received from valve 54 or valve 56.

Synchro valve 82 is configured to generate and transmit a fluid control signal to auxiliary axle brake control valves 66, 68 responsive to the presence of fluid pressure output by double check valve 80. Synchro valve 82 may comprise the valve offered for sale by the applicant Bendix Commercial Vehicle Systems LLC under the model number SV-1™. Valve 82 includes a supply port in fluid communication with a fluid source such as reservoir 46, a control port in fluid communication with the delivery port of double check valve 80, and a delivery port in fluid communication with control ports on auxiliary axle brake control valves 66, 68. When fluid pressure from valve 80 is present at the control port on valve 82 and greater than a predetermined level, valve 82 opens a pathway from the supply port on valve 82 to the delivery port on valve 82 and valve 82 generates and transmits a fluid pressure control signal to auxiliary axle brake control valves 66, 68 thereby causing valves 66, 68 to allow the delivery of fluid pressure from electro-pneumatic drive axle brake control valve 62 to wheel brakes 32 on auxiliary axle 24.

Because of the configuration of fluid control signal generating valve 78, the fluid pressure control signals that cause auxiliary axle brake control valves 66, 68 to deliver fluid pressure to wheel brakes 32 on auxiliary axle 24 are again generated only in response to a command to apply the wheel brakes 28 on steer axle 20. In particular, fluid pressure is only delivered to double check valve 80, and as a result, to synchro valve 82, when either an operator of vehicle 10 inputs a command to apply wheel brakes 28 on steer axle 20 through foot pedal valve 54 or controller 42 generates and transmits a control signal to electro-pneumatic steer axle control valve 56 to implement a command to apply the wheel brakes 28 responsive to a command from the vehicle operator or an automated braking system 72. Once the operator or controller 42 commands a release of wheel brakes 28, fluid pressure between double check valve 80 and foot brake valve 54 is exhausted through valve 54, fluid pressure between double check valve 80 and electro-pneumatic steer axle brake control valve 56 is exhausted through valve 56, fluid pressure between auxiliary axle brake control valves 66, 68 and synchro valve 82 is exhausted through valve 82, fluid pressure between wheel brakes 32 and auxiliary axle brake control valves 66, 68 is exhausted through valves 66, 68 and fluid pressure between electro-pneumatic drive axle brake control valve 62 and auxiliary axle brake control valves 66, 68 is exhausted through valve 62.

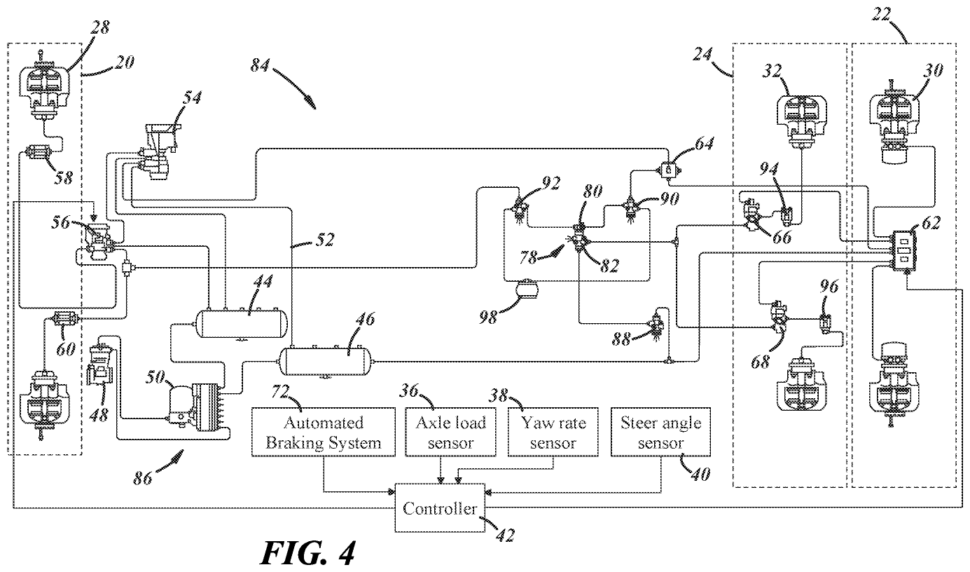

Referring now to FIG. 4, another embodiment of a brake system 84 for a vehicle 10 is illustrated. Like systems 26 and 74, system 84 is provided to slow, stop or prevent rotation of wheels 18 and, therefore, movement of vehicle 10. System 84 is similar to systems 26 and 74 and a description of similar components including wheel brakes 28, 30, 32, sensors 36, 38, 40, and controller 42 may be found hereinabove. System 84 differs from system 26 and system 74 in that system 84 includes a different fluid circuit 86 relative to the fluid circuits 34 and 76 in systems 26 and 74, respectively. Fluid circuit 86 is substantially similar to fluid circuits 34 and 76 and a description of like components including fluid reservoirs 44, 46, compressor 48, air treatment module 50, fluid conduits 52, foot brake valve 54, electro-pneumatic steer axle brake control valve 56, modulators 58, 60, electro-pneumatic drive axle brake control valve 62, quick release valve 64, auxiliary axle brake control valves 66, 68 and fluid control signal generating valve 78 may be found hereinabove. Fluid circuit 86 differs from fluid circuit 76 in that fluid circuit 86 includes several additional valves intended to provide additional functionality to system 84 including pressure reducing valve 88, inversion valves 90, 92 and proportional valves 94, 96.

Pressure reducing valve 88 is provided to reduce the supply pressure for synchro valve 82 and, as a result, the pressure required from double check valve 80 at the control port on synchro valve 82 to open synchro valve 82 making the system more sensitive to low pressure service brake applications. Valve 88 may comprise the valve offered for sale by the applicant Bendix Commercial Vehicle Systems LLC under the model number RV-3™. Valve 88 has a supply port in fluid communication with reservoir 46 and a delivery port in fluid communication with the supply port on synchro valve 82.

Inversion valves 90, 92 are configured to prevent delivery of fluid pressure from foot pedal valve 54 and electro-pneumatic steer axle brake control valve 56, respectively, to double check valve 80 when auxiliary axle 24 comprises a liftable axle and is in an inactive state. Valves 90, 92 may comprise the valve offered for sale by the applicant Bendix Commercial Vehicle Systems LLC under the model number TR-3™. As a result, fluid control signal generating valve 78 will not generate and transmit a fluid control signal to auxiliary axle brake control valves 66, 68 and wheel brakes 32 on auxiliary axle 24 will not be applied when auxiliary axle 24 is in an inactive state despite a command to apply the wheel brakes 28 on steer axle 20. As discussed hereinabove, auxiliary axles 24 may comprise liftable axles that have an inactive state in which the auxiliary axles 24 are in a lifted or raised position and wheels 18 on auxiliary axles 24 are not in contact with the ground and an active state in which the auxiliary axles 24 are in an unlifted or unraised position and wheels 18 on auxiliary axles 24 are in contact with the ground. Actuation of wheel brakes 32 on auxiliary axle 24 when auxiliary axle 24 is in an inactive state would not generate any braking force on vehicle 10 and, conversely, may result in an unnecessary reduction in fluid pressure in system 26 and unnecessary wear on components of system 26. Inversion valve 90 has a supply port coupled to a delivery port on quick release valve 64 and is configured to receive fluid pressure from the food pedal valve 54 through quick release valve 64. Valve 90 has a delivery port coupled to one supply port of double check valve 80 and is configured to deliver fluid pressure to valve 80. Inversion valve 92 has a supply port coupled to a delivery port of electro-pneumatic steer axle brake control valve 56 an is configure to receive fluid pressure from valve 56. Valve 92 has a delivery port coupled to another supply port of double check valve 80 and is configured to deliver fluid pressure to valve 80. Each of inversion valves 90, 92 further have a control port in fluid communication with al lift bag 98 configured to control a position of auxiliary axle 24. When lift bag 98 is inflated and auxiliary axle 24 is a raised position and inactive state, fluid pressure at the control ports on inversion valves 90, 92 will close valves 90, 92 and prevent delivery of fluid pressure to double check valve 80 thereby preventing generation of fluid pressure control signals by synchro valve 82 and delivery of fluid pressure to wheel brakes 32 by auxiliary axle brake control valves 66, 68. When lift bag 98 is uninflated and auxiliary axle 24 is an unraised position and active state, the absence of fluid pressure at the control ports on inversion valves 90, 92 will open valves 90, 92 and allow delivery of fluid pressure to double check valve 80 thereby allowing generation of fluid pressure control signals by synchro valve 82 and delivery of fluid pressure to wheel brakes 32 by auxiliary axle brake control valves 66, 68.

Proportional valves 94, 96 are provided to limit fluid pressure delivered to wheel brakes 32 during service braking at low fluid pressures. Each of valves 94, 96 may comprise the valve offered for sale by the applicant Bendix Commercial Vehicle Systems LLC under the model number LQ-4™. Valve 94 has a supply port in fluid communication with a delivery port of auxiliary axle brake control valve 66 and a delivery port in fluid communication with a wheel brake 32 on one side of auxiliary axle 24 and vehicle 10. Valve 96 has a supply port in fluid communication with a delivery port of auxiliary axle brake control valve 68 and a delivery port in fluid communication with a wheel brake 32 on the opposite side of auxiliary axle 24 and vehicle 10.

A system 26, 74 or 84 for controlling a wheel brake 32 on an auxiliary axle 24 of a vehicle 10 in accordance with the teachings disclosed herein is advantageous relative to conventional systems. In particular, the system 26, 74 or 84 allows an electronic braking system used in controlling wheel brakes 28, 30 on other axles 20, 22 of the vehicle 10 (e.g., the drive axle 22) to indirectly control wheel brakes 32 on the auxiliary axles 24 of a vehicle 10 using components of the electronic braking system and additional fluid control components. The system 26, 74 or 84 therefore enables existing electronic braking systems to control wheel brakes on more axles, and different types of axles, than the electronic braking system may be configured to control with relatively simple and inexpensive changes to the braking system. As a result, the system 26, 74 or 84 enables use of existing electronic braking systems with a larger number of vehicles and types of vehicles. The system 26, 74 or 84 may also allow the extension of certain braking functionality (such as anti-lock braking (ABS)) to auxiliary axles 24 without the addition of dedicated wheel speed sensors and other components of a conventional ABS system. In accordance with one aspect of the systems disclosed herein, the system 26, 74 or 84 is also capable of disabling control of the wheel brakes 32 on the auxiliary axle 24 by the electronic braking system in certain conditions where is may be undesirable for control of auxiliary axle wheel brakes 32 to follow control of wheel brakes 28, 30 on other axles 20, 22 (e.g., in a traction control event or when a liftable auxiliary axle is a lifted position).

While the invention has been shown and described with reference to one or more particular embodiments thereof, it will be understood by those of skill in the art that various changes and modifications can be made without departing from the spirit and scope of the invention.

What is claimed is:

1. A system for controlling a wheel brake on an auxiliary axle of a vehicle, comprising:
an electro-pneumatic drive axle brake control valve configured to deliver fluid pressure from a fluid source to a first drive axle wheel brake on a drive axle of the vehicle responsive to a first electronic control signal;
a first auxiliary axle brake control valve configured to deliver fluid pressure from the electro-pneumatic drive axle brake control valve to a first auxiliary axle wheel brake on the auxiliary axle of the vehicle responsive to a first fluid pressure control signal; and,
a fluid control signal generating valve configured to generate the first fluid pressure control signal responsive to a command to apply a steer axle wheel brake on a steer axle of the vehicle.

2. The system of claim 1 wherein the first drive axle wheel brake and the first auxiliary axle wheel brake are disposed on a first lateral side of the vehicle.

3. The system of claim 1 wherein the electro-pneumatic drive axle brake control valve is further configured to deliver fluid pressure from the fluid source to a second drive axle wheel brake on the drive axle responsive to the first electronic control signal and further comprising a second auxiliary axle brake control valve configured to deliver fluid pressure from the electro-pneumatic drive axle brake control valve to a second auxiliary axle wheel brake on the auxiliary axle of the vehicle responsive to the first fluid pressure control signal.

4. The system of claim 1 wherein the fluid control signal generating valve comprises a solenoid valve that generates the first fluid pressure control signal responsive to a second electronic control signal indicative of the command to apply the steer axle wheel brake on the steer axle of the vehicle.

5. The system of claim 4 wherein the command to apply the steer axle wheel brake on the steer axle of the vehicle is generated in response to an input from an operator of the vehicle.

6. The system of claim 4 wherein the command to apply the steer axle wheel brake on the steer axle of the vehicle is generated by an automated braking system on the vehicle.

7. The system of claim 4 wherein the second electronic control signal is not generated if the auxiliary axle is an inactive state.

8. The system of claim 1 wherein the fluid control signal generating valve comprises:
a double check valve having a first supply port configured to receive a first fluid pressure from an operator controlled valve configured to deliver fluid pressure from the fluid source to both the steer axle wheel brake and the first drive axle wheel brake, a second supply port configured to receive a second fluid pressure from a electro-pneumatic steer axle brake control valve configured to deliver fluid pressure from the fluid source to the steer axle wheel brake, and a delivery port configured to output the higher of the first fluid pressure and the second fluid pressure; and,
a synchro valve having a supply port in fluid communication with the fluid source, a control port in fluid communication with the delivery port of the double check valve, and a delivery port configured to output the first fluid pressure control signal when a level of fluid pressure at the control port is greater than a predetermined level.

9. The system of claim 8, further comprising
a first inversion valve including a supply port configured to receive the first fluid pressure from the operator controlled valve, a delivery port configured to deliver the first fluid pressure to the double check valve, and a control port;
a second inversion valve including a supply port configured to receive the second fluid pressure from the electro-pneumatic steer axle brake control valve, a delivery port configured to deliver the second fluid pressure to the double check valve, and a control port
wherein, the control port of the first inversion valve and the control port of the second inversion valve are in fluid communication with a lift bag configured to control a position of the auxiliary axle.

10. The system of claim 8, further comprising a pressure reducing valve having a supply port in fluid communication with the fluid source and a delivery port in fluid communication with the supply port of the synchro valve, the pressure reducing valve configured to provide a fluid pressure at the supply port of the synchro valve that is less than a fluid pressure of the fluid source.

11. A system for controlling a wheel brake on an auxiliary axle of a vehicle, comprising:
an electro-pneumatic drive axle brake control valve configured to deliver fluid pressure from a fluid source to a first drive axle wheel brake on a drive axle of the vehicle responsive to a first electronic control signal;
means for delivering fluid pressure from the electro-pneumatic drive axle brake control valve to a first auxiliary axle wheel brake on the auxiliary axle of the vehicle responsive to a first fluid pressure control signal; and,
means for generating the first fluid pressure control signal responsive to a command to apply a steer axle wheel brake on a steer axle of the vehicle.

12. The system of claim 11 wherein the first drive axle wheel brake and the first auxiliary axle wheel brake are disposed on a first lateral side of the vehicle.

13. The system of claim 11 wherein the electro-pneumatic drive axle brake control valve is further configured to deliver fluid pressure from the fluid source to a second drive axle wheel brake on the drive axle responsive to the first electronic control signal and further comprising means for delivering fluid pressure from the electro-pneumatic drive axle brake control valve to a second auxiliary axle wheel brake on the auxiliary axle of the vehicle responsive to the first fluid pressure control signal.

14. The system of claim 11 wherein the means for generating the first fluid pressure control signal comprises a solenoid valve that generates the first fluid pressure control signal responsive to a second electronic control signal indicative of the command to apply the steer axle wheel brake on the steer axle of the vehicle.

15. The system of claim 14 wherein the command to apply the steer axle wheel brake on the steer axle of the vehicle is generated in response to an input from an operator of the vehicle.

16. The system of claim 14 wherein the command to apply the steer axle wheel brake on the steer axle of the vehicle is generated by an automated braking system on the vehicle.

17. The system of claim 14 wherein the second electronic control signal is not generated if the auxiliary axle is an inactive state.

18. The system of claim 11 wherein the means for generating the first fluid pressure control signal comprises:
a double check valve having a first supply port configured to receive a first fluid pressure from an operator controlled valve configured to deliver fluid pressure from the fluid source to both the steer axle wheel brake and the first drive axle wheel brake, a second supply port configured to receive a second fluid pressure from a electro-pneumatic steer axle brake control valve configured to deliver fluid pressure from the fluid source to the steer axle wheel brake, and a delivery port configured to output the higher of the first fluid pressure and the second fluid pressure; and,
a synchro valve having a supply port in fluid communication with the fluid source, a control port in fluid communication with the delivery port of the double check valve, and a delivery port configured to output the first fluid pressure control signal when a level of fluid pressure at the control port is greater than a predetermined level.

19. The system of claim 18, further comprising
a first inversion valve including a supply port configured to receive the first fluid pressure from the operator controlled valve, a delivery port configured to deliver the first fluid pressure to the double check valve, and a control port;
a second inversion valve including a supply port configured to receive the second fluid pressure from the electro-pneumatic steer axle brake control valve, a delivery port configured to deliver the second fluid pressure to the double check valve, and a control port
wherein, the control port of the first inversion valve and the control port of the second inversion valve are in fluid communication with a lift bag configured to control a position of the auxiliary axle.

20. The system of claim 18, further comprising a pressure reducing valve having a supply port in fluid communication with the fluid source and a delivery port in fluid communication with the supply port of the synchro valve, the pressure reducing valve configured to provide a fluid pressure at the supply port of the synchro valve that is less than a fluid pressure of the fluid source.
